(19) United States
(12) Patent Application Publication
(10) Pub. No.: US 2012/0127751 A1
(43) Pub. Date: May 24, 2012

(54) DIFFRACTIVE BACKLIGHT STRUCTURE

(75) Inventor: Jyrki Kimmel, Tampere (FI)

(73) Assignee: Nokia Corporation, Espoo (FI)

(21) Appl. No.: 13/128,628

(22) PCT Filed: Oct. 23, 2009
(86) PCT No.: PCT/FI2009/050853

§ 371 Date: Dec. 8, 2011

Related U.S. Application Data
(60) Provisional application No. 61/198,816, filed on Nov. 10, 2008.

(51) Int. Cl. F21V 8/00

(52) U.S. Cl. 362/602; 362/606

(57) ABSTRACT

An apparatus is provided, comprising a plate made substantially of an optical material, the plate comprising: a first surface and an opposing second surface for guiding light components between the first surface and the second surface by reflection; a plurality of edge surfaces configured for receiving the light components into the plate; and a plurality of light diffractive elements distributed on the first surface for directing part of the light components out of the first surface by diffraction.

### FIELD OF THE INVENTION

The present invention relates to a backlight source and, more particularly, to a backlight source having a diffractive structure.

### BACKGROUND OF THE INVENTION

A backlight source is commonly used for providing illumination to a display panel such as a liquid-crystal display (LCD) panel. In some backlight sources, color light-emitting diodes are arranged in a certain pattern for illuminating the LCD panel from the backside thereof.

### SUMMARY OF THE INVENTION

The present invention makes use of the selective diffractive properties of diffractive elements to direct different color light components in a light guide out of one of light guide surfaces. The diffracted light components from the light guide surface form a broad light beam of substantial uniformity for illuminating the backside of a display device, such as a liquid crystal display panel. According to various embodiments of the present invention, a grating structure having an elongated body is used to receive a laser light beam through one end of the elongated body. Fan-out gratings along the elongated body are used to diffract the received laser beam in order to form a light sheet out of a side edge of the elongated body. By placing the grating structure adjacent to one edge of the light guide, the light sheet is thus introduced into the light guide. If only a light sheet of one color is introduced into the light guide, then the diffracted light components out of the light guide surface form a broad light beam of a single color. If two or more light sheets of different colors are introduced into the light guides, then the diffracted light components out of the light guide surface form a broad light beam of multiple colors. If the diffracted light components out of the light guide surface contain three primary color components of red, green and blue in proper proportions, for example, then a broad light beam of white color can be achieved.

According to one embodiment of the present invention, one light guide is used to receive three light sheets in three primary colors in order to form a broad white beam. According to another embodiment of the present invention, two or more light sheets are used to receive light sheets of different colors.

Thus, the first aspect of the present invention is an apparatus or a backlight source, which comprises:

a plate made substantially of an optical material, the plate comprising:
a first surface and an opposing second surface for guiding light components between the first surface and the second surface by reflection;
a plurality of edge surfaces configured for receiving the light components into the plate; and
a plurality of light diffractive elements distributed on the first surface for directing part of the light components out of the first surface by diffraction.

The apparatus further comprises:

one or more grating structures configured for receiving one or more light beams for providing the light components through said one or more edge surfaces, wherein each of said one or more grating structures is configured for receiving a light beam for providing the light components in form of a light sheet. Each of said one or more grating structures comprises an elongated body having at least one side edge along a longitudinal axis and at least one end edge, and wherein the light beam is received through the end edge and the light sheet is provided through the side edge.

According to various embodiment of the present invention, the optical material is chosen such that the light components are guided between the first surface and the second surface by total internal reflection.

According to various embodiments of the present invention, the light components comprise a first color component, a second color component and a third color component, and the light diffractive elements comprise first diffractive elements configured for diffracting the first color component, second diffractive elements configured for diffracting the second color component, and third diffractive elements configured for diffracting the third color component.

According to one embodiment of the present invention, one plate is used as a light guide having a plurality of diffractive elements distributed over one of the light guide surfaces, wherein all of the first, second and third diffractive elements, and wherein different side edges of the plate are used to receive a plurality of light sheets of different colors.

According to another embodiment of the present invention, two or more plates are used as light guides, and each light guide is used to receive a light sheet of a single color. The diffractive elements on the surface of each light guide are configured to diffract the light components of the received light sheet. As such, the diffracted light components out of the surface each light guide form a broad light beam of a different single color. When the plates are stacked on one another, the combination of three broad light beams of three different colors form a broad white light beam.

The aspect of the present invention is a method of realizing a backlight source. The method comprises:

providing a plate made substantially of an optical material, the plate comprising:
a first surface and an opposing second surface for guiding light components between the first surface and the second surface by reflection, and
a plurality of edge surfaces configured for receiving the light components into the plate; and

arranging a plurality of light diffractive elements on the first surface for directing part of the light components out of the first surface by diffraction.

The method further comprises:

arranging one or more grating structures adjacent to said one or more edged surfaces of the plate, the grating structures configured for receiving one or more light beams for providing the light components through said one or more edge surfaces, wherein each of said one or more grating structures is configured for receiving a light beam for providing the light components in form of a light sheet, and wherein each of said one or more grating structures comprises an elongated body having at least one side edge along a longitudinal axis and at least one end edge, and wherein the light beam is received through the end edge and the light sheet is provided through the side edge.

According to the present invention, the optical material is chosen such that the light components are guided between the first surface and the second surface by total internal reflection.

According to one embodiment of the present invention, the light components comprise a first color component, a second color component and a third color component, and wherein the light diffractive elements comprise first diffractive elements configured for diffracting the first color component, second diffractive elements configured for diffracting the second color component, and third diffractive elements configured for diffracting the third color component.

The present invention will become apparent upon reading the description taken in conjunction with FIGS. 1 to 6.

### BRIEF DESCRIPTION OF THE DRAWINGS

FIG. 1 shows a backlight source in relationship with a display panel.

FIG. 2 shows a top view of a backlight source, according to one embodiment of the present invention.

FIG. 3 shows a cross sectional view of the backlight source of FIG. 2.

FIG. 4 shows a backlight source, according to another embodiment of the present invention.

FIG. 5 shows a diffractive structure configured for producing a light sheet from a received laser beam.

FIG. 6 shows a different arrangement of the diffractive elements on a surface of a light guide.

### DETAILED DESCRIPTION OF THE INVENTION

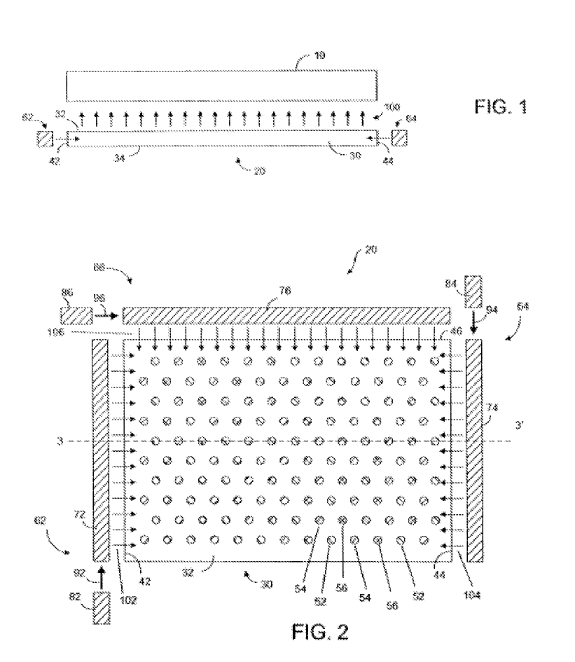

As known in the art, a backlight source is placed on the backside of a display panel to provide illumination to the display panel. As shown in FIG. 1, a backlight source 20 is placed on the backside of the display panel 10, such as a liquid-crystal display panel. According to various embodiments of the present invention, the backlight source 20 has a backlight plate 30 and a plurality of light sources 62, 64 to provide a plurality of light beams into the backlight plate 30 from the edges 42 and 44. In addition, another light source 66 is also used to provide a light beam from another edge 46 of the backlight plate 30 as shown in FIG. 2. As shown in FIG. 1, the backlight plate 30 has a first surface 32 facing the display panel 10 and an opposing second surface 34. Light from the backlight plate 30 is directed to the backside to the display panel 10 as a broad light beam 100 mainly through the first surface 32.

FIG. 2 shows a top view of the backlight source 20 of the present invention. The backlight plate 30 can be rectangular in shape and has four edges, for example. As such, three or four light sources can be placed near the edges to provide a plurality of light beams into the backlight plate through the edges. As shown in FIG. 2, the light source 62 comprises a light directing structure 72 configured to direct a red laser beam 92 into the backlight plate 30 through the edge 42, the light source 64 comprises a light directing structure 74 configured to direct a blue laser beam 94 into the backlight plate 30 through the edge 44, and the light source 66 comprises a light directing structure 76 configured to direct a green laser beam 96 into the backlight plate 30 through the edge 46. The light directing structures 72, 74 and 76 receive light beams 92, 94 and 96 from their edges, for example. Each of the light directing structures 72, 74 and 76 comprises light directing elements such as fan-out gratings in order to expand the received light beam 92, 94 or 96 into a light sheet 102, 104 or 106. The light beams 92, 94 and 96 can be laser beams of red color, blue color and green color, for example, and the light sheets 102, 104 and 106 are light sheets of red color, blue color and green color. The light beams 92, 94 and 96 can be separately provided by lasers 82, 84 and 86. The fan-out gratings in the light directing structures 72, 74 and 76 are configured to diffract the light beams in red, blue and green, respectively.

On the surface 32 of the backlight plate 30, a plurality of diffractive elements 52, 54 and 56 distributed throughout the surface 32. The diffractive elements 52 are configured to diffract more effectively a red light beam, the diffractive elements 54 are configured to diffract more effectively a blue light beam, and the diffractive elements 56 are configured to diffract more effectively a green light beam. Preferably, the diffractive elements 52, 54 and 56 are arranged in an array, such as a delta array, as shown in FIG. 2. In a delta array, each of the diffraction elements 52, 54 and 56 is located at a corner of a triangle.

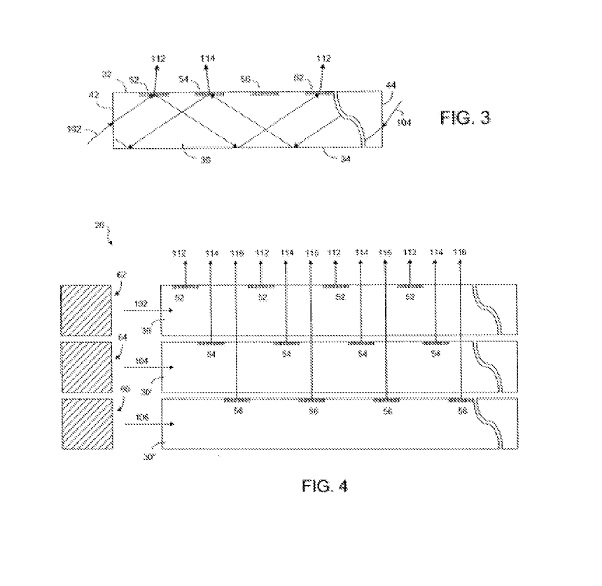

FIG. 3 shows a cross sectional view of the backlight plate 30, according to one embodiment of the present invention. As shown in FIG. 3, the first surface 32 of the backlight plate 30 comprises an array of diffractive elements 52, 54 and 56. After the light sheet 102 enters the backlight plate 30 through the edge 42, the light sheet 102 is guided between the first surface 32 and the second surface 34 by way of total internal reflection (TIR), for example. When part of the light sheet 102 encounters the diffractive elements 52, it is diffracted out of the first surface 32. The diffracted light from the diffractive elements 52 forms a broad light beam of the same color out of the first surface 32 of the backlight plate 30. Likewise, after the light sheet 104 enters the backlight plate 30 through the edge 44, the light sheet 102 is guided between the first surface 32 and the second surface 34 by way of total internal reflection. When part of the light sheet 104 encounters the diffractive elements 54, it is diffracted out of the first surface 32. The diffracted light from the diffractive elements 54 forms a broad light beam of the same color out of the first surface 32 of the backlight plate 30. After the light sheet 106, as shown in FIG. 2, enters into the backlight plate 30 through another edge of the backlight plate 30, the light sheet 106 is also guided between the first surface 32 and the second surface 34 by way of total internal reflection. As with the light sheets 102 and 104, part of the light sheet 106 encounters the diffractive elements 56 and is diffractive out of the first surface 32 to form a broad beam.

As an example, the light beam 92 is a red laser beam and the diffracted light 112 from the diffractive elements 52 forms a red light beam away from the first surface 32; the light beam 94 is a blue laser beam and the diffracted light 114 from the diffractive elements 54 forms a blue light beam away from the first surface 32; and the light beam 96 is a green laser beam and the diffracted light 112 from the diffractive elements 56 forms a green light beam away from the first surface 32. As a result, a broad white light beam 100 is formed. This broad white light beam can be used to illuminate a display panel from the backside of the display panel 10, as shown in FIG. 1.

In the above-described example, three light beams 92, 94 and 96 of red, blue and green colors are used to form a white light beam for illumination. It should be noted that, the color of the light beams and the number of the light beams can be different depending on the application. For example, if it is desirable to form a broad light beam of a single color for illumination, it is possible to use one, two or more laser beams of the same color as the light source. Accordingly, one, two or more light directing structures with fan-out gratings configured for forming one, two or more light sheets, and all the diffractive elements are configured for diffracting light of that single color. If it is desirable to provide a broad light beam composed of two primary colors such as red and blue, it is possible to use one or two red light beams 92 and one or two blue light beams 94 to form a number of light sheets 102 and 104. It is more effective that the diffractive elements on the first surface 32 comprise only diffractive elements 52 and 54. In some applications where a broad beam of an ultraviolet wavelength is desirable, it is possible to fabricate on the first surface a plurality of diffractive elements configured to diffract that ultraviolet wavelength. Likewise, diffractive elements configured to diffract infrared can be used to form a broad infrared beam out of the first surface 32 of the plate 30, for example.

In another embodiment of the present invention, two or more backlight plates are stacked one on top another to form a single backlight source, as shown in FIG. 4. As shown in FIG. 4, three separate backlight plates 30, 30′ and 30″ are used to form a backlight source 20. On the first surface 32 of the backlight plate 30, a plurality of diffractive elements 52 are formed to diffract light from the light sheet 102 provided by the light source 62. On the first surface 32′ of the backlight plate 30′, a plurality of diffractive elements 54 are formed to diffract light from the light sheet 104 provided by the light source 64. On the first surface 32″ of the backlight plate 30″, a plurality of diffractive elements 56 are formed to diffract light from the light sheet 106 provided by the light source 66.

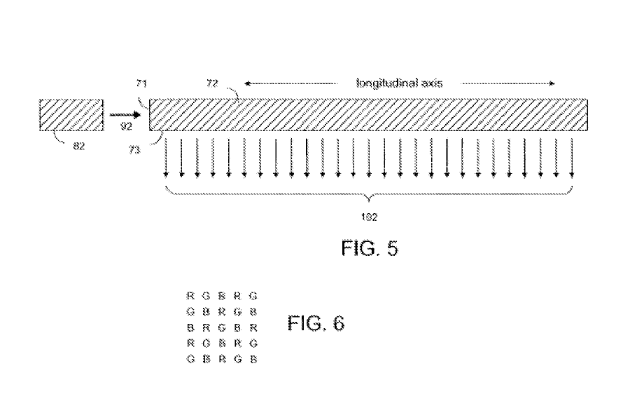

Each of the diffractive structures 72, 74 and 76 can be an elongated body made of an optical material. For example, the diffractive structure 72 has an elongated body with at least one side edge 73 along a longitudinal axis and at least one end edge 71 so that the light beam 92 from the laser 82 can be received through the end edge 71 and the light sheet 102 is provided through the side edge 73, as shown in FIG. 5.

It should be noted that diffractive elements 52, 54 and 56 on the surface 30 can be holographically produced or otherwise. Likewise, the fan-out gratings in the diffractive structures 72, 74 and 76 can also be holographically produced, for example. The diffractive structures can be replaced by other structures that can produce a light sheet from a laser beam. It should also be noted that the diffractive elements 52, 54 and 56 have been described as being arranged in a delta array in which each different one of the diffractive elements is located in one corner of a triangle, but a different array can also be used to arrange the diffractive elements. For example, the diffractive elements configured for diffracting the color light sheets in R, G and B can be arranged in a rectangular or a square array as shown in FIG. 6.

In summary, the present invention is concerned with light guide arranged for receiving light sheets of different colors through its edge surfaces. Diffractive elements are distributed one of the light guide surfaces for diffracting part of the light sheets out of the light guide surface. The diffractive elements include those for diffracting red color, those for diffracting blue color and those for diffracting green colors. Diffracted light of different colors forms a broad light beam of white color. A grating structure having an elongated body is used to receive a laser light beam through one end of the body, and fan-out gratings along the body are used to diffract the received laser beam for forming a light sheet out of a side edge. The grating structure is placed adjacent to one edge of the light guide so as to introduce the light sheet into the light guide

The present invention provides an apparatus which comprises:

a plate made substantially of an optical material, the plate comprising:
a first surface and an opposing second surface for guiding light components between the first surface and the second surface by reflection;
a plurality of edge surfaces configured for receiving the light components into the plate; and
a plurality of light diffractive elements distributed on the first surface for directing part of the light components out of the first surface by diffraction.

According to various embodiments of the present invention, the apparatus further comprises:

one or more grating structures configured for receiving one or more light beams for providing the light components through said one or more edge surfaces.

According to various embodiments of the present invention, the optical material is chosen such that the light components are guided between the first surface and the second surface by total internal reflection, and each of said one or more grating structures is configured for receiving a light beam for providing the light components in form of a light sheet.

According to various embodiments of the present invention, each of said one or more grating structures comprises an elongated body having at least one side edge along a longitudinal axis and at least one end edge, and wherein the light beam is received through the end edge and the light sheet is provided through the side edge.

According to various embodiments of the present invention, the light components comprise a first color component, a second color component and a third color component, and wherein the light diffractive elements comprise first diffractive elements configured for diffracting the first color component, second diffractive elements configured for diffracting the second color component, and third diffractive elements configured for diffracting the third color component.

According to various embodiments of the present invention, the first color component is a red light component, the second color component is a green light component and the third color component is a blue light component.

The present invention also provides a method, which comprises:

providing a plate made substantially of an optical material, the plate comprising:
a first surface and an opposing second surface for guiding light components between the first surface and the second surface by reflection, and
a plurality of edge surfaces configured for receiving the light components into the plate; and

arranging a plurality of light diffractive elements on the first surface for directing part of the light components out of the first surface by diffraction.

According to various embodiments of the present invention, the method further comprises: arranging one or more grating structures adjacent to said one or more edged surfaces of the plate, the grating structures configured for receiving one or more light beams for providing the light components through said one or more edge surfaces.

1-28. (canceled)

29. An apparatus comprising:
a plate comprising an optical material, the plate comprising:
a first surface and an opposing second surface configured to guide light components between the first surface and the second surface by reflection;
a plurality of edge surfaces configured to receive the light components into the plate; and
a plurality of light diffractive elements distributed on the first surface and configured to direct at least part of the light components out of the first surface by diffraction.

30. An apparatus as in claim 29, comprising:
at least one grating structure configured to receive at least one light beam and to provide the light components through at least one of the plurality of edge surfaces.

31. An apparatus as in claim 30, wherein the at least one grating structure is configured to receive the at least one light beam and provide the light components in the form of a light sheet.

32. An apparatus as in claim 30, wherein the at least one grating structure comprises an elongated body having at least one side edge along a longitudinal axis and at least one end edge, configured to receive the at least one light beam through the end edge and provide the light sheet through the side edge.

33. An apparatus as in claim 29, wherein the optical material is such that the light components are guided between the first surface and the second surface by total internal reflection.

34. An apparatus as in claim 29, wherein the light components comprise a first color component, a second color component and a third color component, and wherein the light diffractive elements comprise first diffractive elements configured to diffract the first color component, second diffractive elements configured to diffract the second color component, and third diffractive elements configured to diffract the third color component.

35. An apparatus as in claim 34, wherein the first color component is a red light component, the second color component is a green light component and the third color component is a blue light component.

36. An apparatus as in claim 29, wherein the light components comprise an ultraviolet light component.

37. An apparatus as in claim 29, wherein the light components comprise an infrared light component.

38. An apparatus as in claim 30, wherein the at least one light beam comprises a laser beam.

39. An apparatus as in claim 29, configured to form a broad white light beam from the light components.

40. An apparatus as in claim 29, comprised in a backlight source for a display device.

41. A method, comprising:
receiving light components through at least one edge surface of a plate comprising an optical material,
guiding the light components by reflection between a first surface and an opposing second surface of the plate, and
directing part of the light components out of the first surface by diffraction.

42. A method as in claim 41, comprising:
receiving at least one light beam in at least one grating structure, and providing the light components through the at least one edge surface.

43. A method as in claim 42, wherein
the at least one light beam is expanded into a light sheet.

44. A method as in claim 41, the at least one grating structure comprising an elongated body having at least one side edge along a longitudinal axis and at least one end edge, wherein the at least one light beam is received through the at least one end edge and the light sheet is provided through the at least one side edge.

45. A method as in claim 41, wherein the light components are guided between the first surface and the second surface by total internal reflection.

46. A method as in claim 41, the light components comprising a first color component, a second color component and a third color component, wherein the method comprises:
diffracting the first color component with first diffractive elements;
diffracting the second color component with second diffractive elements, and diffracting the third color component with third diffractive elements.

47. A method as in claim 46, wherein the first color component comprises a red light component, the second color component comprises a green light component and the third color component comprises a blue light component.

48. A method as in claim 41, wherein the light components comprise at least one of ultraviolet light component and infrared light component.
